(19) United States
(12) Patent Application Publication
(10) Pub. No.: US 2009/0032524 A1
(43) Pub. Date: Feb. 5, 2009

(54) THREE-DIMENSIONAL ELECTRIC HEATING APPARATUS

(76) Inventors: Chen-Liang Li, Jhonghe City (TW); Han-Hsing Hsiung, Hsinchu Hsien (TW)

Correspondence Address: PATTERSON & SHERIDAN, L.L.P., 3040 POST OAK BOULEVARD, SUITE 1500, HOUSTON, TX, 77056, US

(21) Appl. No.: 12/183,993

(22) Filed: Jul. 31, 2008

(30) Foreign Application Priority Data
Aug. 1, 2007 (TW) 96128285

(51) Int. Cl. H05B 3/34

(52) U.S. Cl. 219/529

(57) ABSTRACT

A three-dimensional electric heating apparatus includes a pouch-like electric heating knitted fabric, a protective layer, and a thermal insulating device. The electric heating knitted fabric is utilized to accommodate and heat a container while the electric heating knitted fabric elastically fits around the container. The protective layer is located on a surface of the electric heating knitted fabric facing the container. The thermal insulating device is located on another surface of the electric heating knitted fabric so as to insulate the heat generated by the electric heating knitted fabric.

### RELATED APPLICATIONS

This application claims priority to Taiwan Application Serial Number 96128285, filed Aug. 01, 2007, which is herein incorporated by reference.

### FIELD OF THE INVENTION

The present invention relates to a heating apparatus, particularly to a three-dimensional electric heating apparatus.

### BACKGROUND OF THE INVENTION

In the consideration of healthy living and personal taste, modern-day people are becoming more and more concerned about the need for the warmth keeping of beverages, wherein the most eager needs are of the office workers who work in an office for long periods of time. Furthermore, in current various commonly used methods for thermal insulation of beverages; insulation by electric heating best meets the needs of office workers.

An electric thermos is currently a common apparatus for insulation by electric heating. By being electrically powered, the electric thermos can heat up the beverage contained inside to maintain the temperature of the beverage in the electric thermos. However, when wanting to heat up a beverage, the beverage must be poured into the electric thermos to be heated, thereby causing a considerable inconvenience in use.

Another common apparatus used for thermal insulation by electric heating is a container-shaped electric heating apparatus, which directly heats a container holding a beverage to be heated. This method of heating does not require the beverage to be poured into an electric thermos, but the electric heating apparatus has limits with shape and volume, thereby the shape and volume of the container to be heated is also often limited.

Therefore, a heating apparatus that can elastically expand is currently needed.

### SUMMARY OF THE INVENTION

In one aspect of the present invention, a three-dimensional electric heating apparatus with elastically expandable capabilities is provided.

According to an embodiment of the present invention, a three-dimensional electric heating apparatus comprises an electric heating knitted fabric, a protective layer, and a thermal insulating device. The electric heating knitted fabric is pouch-like to accommodate and heat a container, and allow the electric heating knitted fabric to elastically fit around the container. The protective layer is located on a side of the electric heating knitted fabric facing the container. The thermal insulating device is located on the other side of the electric heating knitted fabric and used for insulating the heat generated by the electric heating knitted fabric.

According to another embodiment of the present invention, a three-dimensional electric heating apparatus comprises an electric heating fabric, a protective layer, and a thermal insulating device. The electric heating fabric is pouch-like and comprises electro-heating fibers and high twist fibers. The electric heating fabric can elastically fit around and heat a container accommodated therein. The protective layer is located on a side of the electric heating fabric facing the container. The thermal insulating device is on the other side of the electric heating fabric and used for insulating the heat generated by the electric heating fabric.

The aforementioned pouch-like electric heating fabric of the three-dimensional electric heating apparatus can elastically fit around a container to be heated during the heating operation. In comparison with a conventional planar heating apparatus, the three-dimensional electric heating apparatus according to the embodiments of the present invention can provide three-dimensional heating by fitting around a container. As such, the heated area of the container is further increased, thereby improving heating efficiency. Furthermore, the elastically expandable capabilities of the aforementioned electric heating fabric also allows the three-dimensional electric heating apparatus to be able to heat containers of various volumes and shapes, thereby further increasing the application of the three-dimensional electric heating apparatus according to the embodiments of the present invention.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A is a schematic perspective view illustrating an unemployed three-dimensional electric heating apparatus according to an embodiment of the present invention.

FIG. 1B is a cross-sectional view illustrating the structure taken along the line A-A′ in FIG. 1A.

FIG. 1C is a schematic view illustrating the fabric structure of the electric heating fabric in FIG. 1B.

FIG. 2A is a cross-sectional view illustrating the three-dimensional electric heating apparatus according to another embodiment of the present invention.

FIG. 2B is a cross-sectional view illustrating the three-dimensional electric heating apparatus in FIG. 2A with a container to be heated disposed therein.

### DETAILED DESCRIPTION OF THE PREFERRED EMBODIMENT

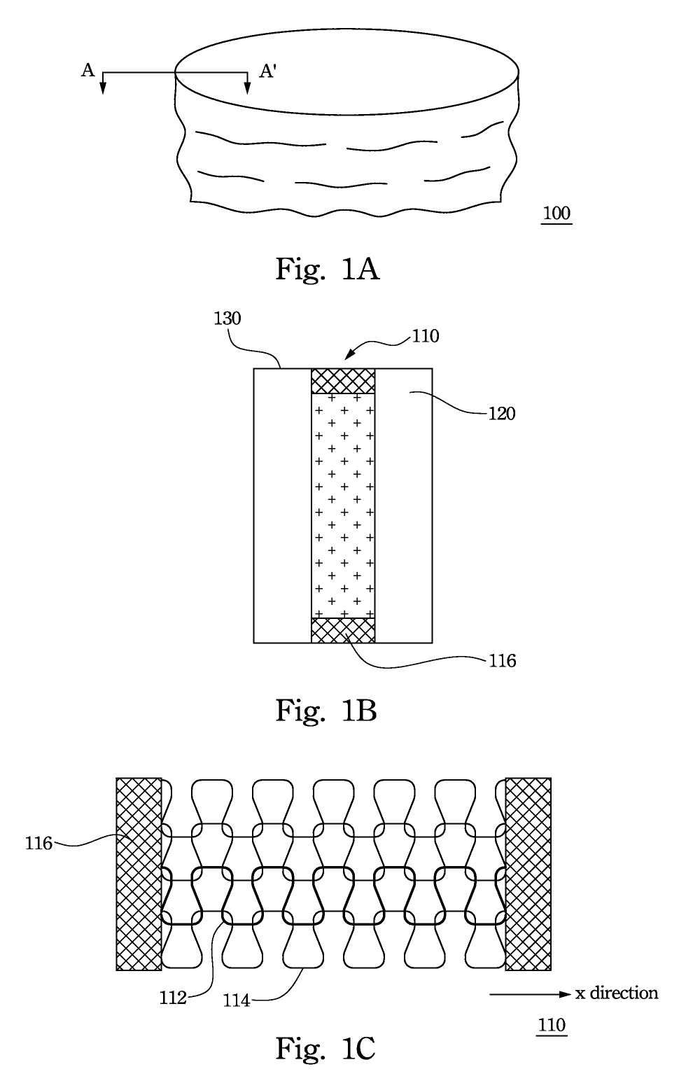

FIG. 1A is a schematic perspective view illustrating an unemployed three-dimensional electric heating apparatus according to an embodiment of the present invention. FIG. 1B is a cross-sectional view illustrating the structure taken along the line A-A′ in FIG. 1A. FIG. 1C is a schematic view illustrating the fabric structure of the electric heating fabric 110 in FIG. 1B. Referring to FIGS. 1A-1C, the three-dimensional electric heating apparatus 100 comprises a pouch-like electric heating fabric 110, and a protective layer 120 as well as a thermal insulating layer 130 respectively located on opposite sides of the electric heating fabric 110.

The electric heating fabric 110 is a pouch-like electric heating fabric with elastically expandable capabilities, and can be used on containers of various shapes and volumes to give different levels of stretching, thereby containing and elastically fitting around containers of various shapes and volumes. In order to impart the elastically expandable capabilities of the electric heating fabric 110, the electric heating fabric 110 may be woven by knitting electro-heating fibers 112 with general textile fibers in one example. According to this example, the extension rate in width of the electric heating fabric 110 is about 10-60%, and the extension rate in length of the electric heating fabric 110 is about 5-30%.

In another example, the electric heating fabric 110 may also be woven by weaving electro-heating fibers 112 with high twist fibers, wherein using the high twist fibers can also impart the elastically expandable capability of the electric heating fabric 110. The twist of the high twist fibers is about 800-4000 Twist/m. High twist fibers may be a combination of S-twisted yarns and Z-twisted yarns.

Referring to FIG. 1C, the electro-heating fibers 112 may be woven with the textile fiber or high twist fibers 114 in the zigzag arrangement shown in FIG. 1C so as to obtain the electric heating fabric 110. In this example, the extension rate in the X direction is larger than that of other directions. When the electric heating fabric 110 is stretched in the X direction, the electro-heating fibers 112 can be stretched in accordance with the electric heating fabric 110 and be straightened. In this way, the extension rate of the electro-heating fibers 112 in specific direction can be improved by the zigzag arrangement in addition to the intrinsic elasticity of the fibers.

The aforementioned electro-heating fibers 112 may be, for example, metal fibers, metal alloy fibers, or carbon fibers. The diameters of the metal fibers and the metal alloy fibers are about 1-1000 micrometers, while the denier of the carbon fibers is about 1000-12000 denier.

Referring again to FIG. 1C, the electro-heating fibers 112 can electrically connect to an external power device by electrodes 116 so as to carry out heating. The electrode 116 may be, for example, metal foil tape or electrically conductive fibers, and is stitched or woven onto the edge of the electric heating fabric 110.

Referring again to FIGS. 1A-1C, the aforementioned protective layer 120 is located on a first surface of the electric heating fabric 110 facing a container to be heated. The protective layer 120 is made of fabric that has electrically insulating and waterproof capabilities. The aforementioned electrically insulating capability can electrically insulate the electrodes 116 or the electro-heating fibers 112 in the electric heating fabric 110 to prevent the risk of electrical shock from happening. The waterproof capability can prevent the beverage in the container to be heated from accidentally leaking into and permeating the electric heating fabric 110 that could result in a short circuit in the electro-heating fibers 112.

The aforementioned protective layer 120 may also have elastically expandable capabilities to elastically fit around a container in conjunction with the electric heating fabric 110. In order for the protective layer 120 to have elastically expandable capabilities, the protective layer 120 may be woven by knitting, or the protective layer 120 may be made by weaving elastic high twist fibers.

The aforementioned thermal insulating layer 130 can be used to insulate heat generated by the electric heating fabric 110. The thermal insulating layer 130 may be knitted fabric or woven fabric woven with elastic high twist fibers. As such, when the electric heating fabric 110 is stretched out, the thermal insulating layer 130 may also correspondingly expand in accordance with the electric heating fabric 110. The thermal insulating layer 130 may also be woven with thermal insulating fabric without an expandable capability. In this case, the thermal insulating fabric needs to be larger than the electric heating fabric 110, and the edge of the thermal insulating fabric is sewn onto the electric heating fabric 110. Before any container is inserted into the electric heating fabric 110, a considerably large space exists between the thermal insulating fabric and the electric heating fabric 110. When a container to be heated is inserted therein, the electric heating fabric 110 is stretched out and occupies the aforementioned space.

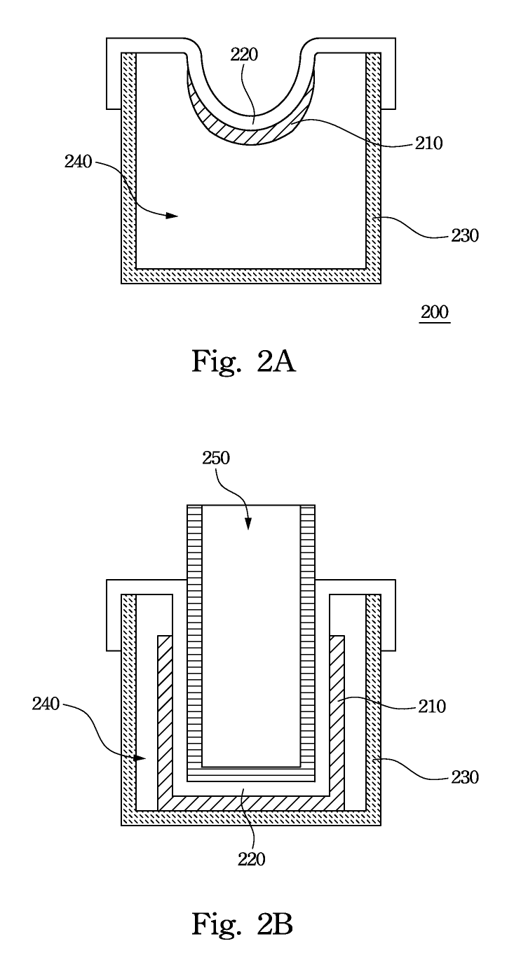

FIG. 2A is a cross-sectional view illustrating the three-dimensional electric heating apparatus according to another embodiment of the present invention. FIG. 2B is a cross-sectional view illustrating the three-dimensional electric heating apparatus in FIG. 2A with a container to be heated disposed therein. Referring to both FIGS. 2A and 2B, the three-dimensional electric heating apparatus 200 comprises an electric heating fabric 210, a protective layer 220 and a support 230 in the shape of a container. The material and structure of the electric heating fabric 210 and the protective layer 220 are the same as the electric heating fabric 110 and the protective layer 120 shown in FIGS. 1A-1C. The difference between this embodiment and the aforementioned embodiment is that the three-dimensional electric heating apparatus 200 shown in this embodiment utilizes the support 230 in the shape of a container as a thermal insulating device, and the support 230 may be made of fabric or other plastic material. The electric heating fabric 210 and the protective layer 220 are located within the support 230, and a portion of the protective layer 220 covers the edge of the support 230. When not in use, a space 240 exists between the electric heating fabric 210 and the support 230. When a container 250 is placed into the three-dimensional electric heating apparatus 200, the electric heating fabric 210 fits around the container 250 and carries out heating, and the electric heating fabric 210 and the protective layer 220 are further stretched out.

According to the embodiments described herein, when the pouch-like electric heating fabric of the three-dimensional electric heating apparatus carries out heating, the electric heating fabric can elastically fit around a container to be heated. In comparison with a conventional planar heating apparatus, the three-dimensional electric heating apparatus according to the embodiments of the present invention can provide three-dimensional heating by fitting around a container. As such, the heated area of a container can further be increased, thereby improving heating efficiency. Furthermore, the elastically expandable capabilities of the aforementioned electric heating fabric can also allow the aforementioned three-dimensional electric heating apparatus to heat containers of various volumes and shapes, thereby further increasing the use of the aforementioned three-dimensional electric heating apparatus.

As is understood by a person skilled in the art, the foregoing preferred embodiments of the present invention are illustrated of the present invention rather than limiting of the present invention. It is intended to cover various modifications and similar arrangements included within the spirit and scope of the appended claims. Therefore, the scope of this invention should be accorded the broadest interpretation so as to encompass all such modifications and similar structure.

What is claimed is:

1. A three-dimensional electric heating apparatus, comprising:
a pouch-like electric heating knitted fabric elastically fitting around a container to accommodate and heat the container therein;
a protective layer located on a first surface of the electric heating knitted fabric facing the container; and
a thermal insulating device located on a second surface of the electric heating knitted fabric opposing to the first surface so as to insulate heat generated by the electric heating knitted fabric.

2. The three-dimensional electric heating apparatus of claim 1, wherein the electric heating knitted fabric has an extension rate in width of about 10-60%, and an extension rate in length of about 5-30%.

3. The three-dimensional electric heating apparatus of claim 1, wherein the protective layer has a knitted structure so that the protective layer elastically fits around the container in conjunction with the electric heating knitted fabric.

4. The three-dimensional electric heating apparatus of claim 1, wherein the protective layer has a woven structure woven with at least one high twist fiber, and wherein the twist of the high twist fiber is about 800-4000 Twist/m so that the protective layer elastically fits around the container in conjunction with the electric heating knitted fabric.

5. The three-dimensional electric heating apparatus of claim 1, wherein the thermal insulating device is a thermal insulating fabric sewn onto the second surface of the electric heating knitted fabric opposing to the first surface of the electric heating knitted fabric.

6. The three-dimensional electric heating apparatus of claim 5, wherein the thermal insulating fabric has a knitted structure.

7. The three-dimensional electric heating apparatus of claim 1, wherein the thermal insulating device is a container-shaped support, and the electric heating knitted fabric and the protective layer are disposed within the support.

8. The three-dimensional electric heating apparatus of claim 1, further comprising a plurality of electrodes located on the electric heating knitted fabric, wherein the plurality of electrodes are electrically connected to the electric heating knitted fabric.

9. A three-dimensional electric heating apparatus, comprising:
a pouch-like electric heating fabric comprising an electro-heating fiber and a high twist fiber, wherein the high twist fiber has a twist of about 800-4000 Twist/m, and wherein the electric heating fabric elastically fits around and heats a container disposed therein;
a protective layer located on a first surface of the electric heating knitted fabric facing the container; and
a thermal insulating device located on a second surface of the electric heating knitted fabric facing so as to insulate heat generated by the electric heating fabric.

10. The three-dimensional electric heating apparatus of claim 9, wherein the protective layer has a knit structure so that the protective layer elastically fits around and heats a container in conjunction with the electric heating fabric.

11. The three-dimensional electric heating apparatus of claim 9, wherein the protective layer has a woven structure woven with at least one high twist fiber, and wherein the twist of the high twist fiber is about 800-4000 Twist/m so that the protective layer elastically fits around and heats the container in conjunction with the electric heating knitted fabric.

12. The three-dimensional electric heating apparatus of claim 9, wherein the thermal insulating device is a thermal insulating fabric sewn onto the second surface of the electric heating fabric opposing to the first surface of the electric heating fabric.

13. The three-dimensional electric heating apparatus of claim 12, wherein the thermal insulating fabric has a knit structure.

14. The three-dimensional electric heating apparatus of claim 9, wherein the thermal insulating device is a container-shaped support, and the electric heating fabric and the protective layer are disposed within the support.

15. The three-dimensional electric heating apparatus of claim 9, further comprising a plurality of electrodes located on the electric heating fabric, wherein the plurality of electrodes are electrically connected to the electric heating fabric.
